(19) United States
(12) Patent Application Publication
(10) Pub. No.: US 2010/0077783 A1
(43) Pub. Date: Apr. 1, 2010

(54) Solid oxide fuel cell assisted air conditioning system

(76) Inventors: Mohinder S. Bhatti, Williamsville, NY (US); John F. O'Brien, Lockport, NY (US); Ilya Reyzin, Williamsville, NY (US); Malcolm J. Grieve, Fairport, NY (US); Sean M. Kelly, Pittsford, NY (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/286,371

(22) Filed: Sep. 30, 2008

(51) Int. Cl. F25D 21/00; F28F 3/14; H01M 8/10; F24H 3/02; H01M 8/04

(52) U.S. Cl. 62/271; 165/170; 429/30; 165/121; 429/26

(57) ABSTRACT

A housing rotatably supports a desiccant wheel, Ambient air passes through one part of the housing and hot exhaust air passes through the other part. As the wheel rotates, it absorbs moisture from the ambient air in part of the housing and desorbs moisture into the exhaust air in the other part. A fuel cell system supplies the hot exhaust air directly to the desiccant wheel, The dry ambient air is directed to an evaporative cooler and divided between dry channels and wet channels, The air passing through the dry channels cools to be directed to a conditioned space. The air passing through the wet channels evaporates water in the channels facilitating heat transfer and adding moisture to that air. The air from the wet channels is optionally added back into the air from the dry channels to provide appropriate humidity.

### BACKGROUND OF THE INVENTION

1. Field of the Invention

An air conditioning system for comfort cooling, heating, humidification and dehumidification of air.

2. Description of the Prior Art

In a broad sense, the term air conditioning refers to heating, cooling, humidification, dehumidification as well as cleaning of air for comfort and other purposes. The subject invention is directed at four-season air conditioning of commercial and residential buildings. The most dominant air conditioning system for comfort cooling is the vapor compression system, which uses electric power to drive the compressor. It is not intended to provide comfort heating. The most common air conditioning system for comfort heating is the fuel-fired system, which is quite energy efficient, but is incapable of providing comfort cooling. The most common air conditioning system capable of providing both comfort heating and cooling is the heat pump system, which like vapor compression system uses electric power to drive the compressor and as such is not as energy efficient as the fuel-fired system. The objective of the present invention is to provide an energy efficient air conditioning system, which operates with minimal use of electric power and is capable of providing both comfort heating and cooling.

The subject air conditioning system utilizes an indirect evaporative cooler to abstract heat from the ambient air. In an indirect evaporative cooler, the dry and wet air streams do not come in direct contact with each other and as such the absolute humidity of the dry air does not change during its passage through the dry channels of the evaporative cooler. However, its dry bulb temperature drops, which is the desired effect in summer time. For proper comfort cooling, the absolute humidity of the cold air stream exiting the dry channels of the evaporative cooler must remain low. Thus an indirect evaporative cooler is superior to a direct evaporative cooler since in the latter the dry and wet air streams mix resulting in higher absolute humidity of the conditioned air. Examples of an indirect evaporative cooler can be found in the U.S. Pat. Nos. 6,497,107; 4,977,753 and 4,976,113.

Since an indirect evaporative cooler is incapable of dehumidifying the air a desiccant wheel is incorporated in the air conditioning system to dehumidify the ambient air preparatory to its entry into the evaporative cooler. Examples of the air conditioning systems incorporating desiccant wheels to dehumidify the ambient air can be found in the U.S. Pat. Nos. 5,660,048; 5,727,394; 5,758,508; 5,860,284; 5,890,372; 6,003,327; 6,018,953 and 6,050,100.

A desiccant-assisted indirect evaporative cooler does not require much electric power. The small amount of electric power required to turn the desiccant wheel and to power the blower can be drawn from a solid oxide fuel cell (SOFC) system. Also the thermal energy required to regenerate the desiccant wheel, i.e., to drive off the adsorbed moisture therefrom and to dehumidify the ambient air is abstracted from the hot exhaust of the SOFC system. Examples of the fuel cell systems providing power for air conditioning systems can be found in the Japanese Patents 2000-274734 and 2004-183962.

### SUMMARY OF THE INVENTION AND ADVANTAGES

The major components of the air conditioning system are a desiccant wheel, an indirect evaporative cooler and a SOFC system.

The desiccant wheel removes moisture from the air flowing through one side thereof. It comprises an array of tubes lined with a desiccant material, i.e., a water adsorbent material, extending axially inside the desiccant wheel, which is rotatably disposed within a housing having holes therethrough. Air to be dehumidified is directed through one portion of the housing and through the rotating wheel, which adsorbs the moisture from the air. To remove the adsorbed moisture from, i.e., to regenerate the desiccant material, a stream of hot dry air is directed through the other portion of the wheel with adsorbed water vapor. Thus, the desiccant wheel rotates to alternatively adsorb and desorb moisture. During adsorption process, the dry bulb temperature of the air increases as its absolute humidity decreases. Thus the desiccant wheel converts the latent air conditioning load due to dehumidification of moist air to sensible air conditioning load due to increase in dry bulb temperature of the dehumidified air. This conversion of latent-to-sensible load constitutes an important step in adaption of the desiccant wheel assisted indirect evaporative cooler system to provide properly conditioned air for comfort. The total air conditioning load after dehumidification is all sensible whereas prior to entry into the desiccant wheel it is partly latent and partly sensible.

An indirect evaporative cooler, capable of handling increased sensible load due to dehumidification, cools the hot dehumidified air generated by the desiccant wheel. It comprises arrays of transversely disposed wet and dry channels, which are in communication with the dehumidified air outlet of the desiccant wheel. The wet channels are lined with a wicking material, which receives liquid water by capillary action from a water tank. As the dehumidified air generated by the desiccant wheel flows through the dry channels of the indirect evaporative cooler, a fraction of this air is siphoned off into the wet channels lined with a wicking material. The dehumidified air in the wet channels evaporates the liquid water in the wicking material by abstracting heat from the dry air in the contiguous dry channels.

In winter time, most of the dehumidified hot air generated by the desiccant wheel is directed through the dry channels of the indirect evaporative cooler and only a small fraction of this air is directed through the wet channels for the purpose of humidifying the conditioned hot air exiting the indirect evaporative cooler. Thus in winter time there is practically no cooling of the dehumidified hot air as it flows through the indirect evaporative cooler and enters the conditioned space.

A solid oxide fuel cell (SOFC) system is in communication with the regeneration section of the desiccant wheel providing hot exhaust to drive off moisture adsorbed in the dehumidification section of the wheel. The desiccant wheel transfers moisture from the ambient air to the desiccant material to form a complex compound. The SOFC system supplies hot exhaust air which removes the moisture from the desiccant material by decomposing the complex molecule formed by the adsorbed water vapor and the desiccant material. The SOFC system receives some dehumidified air from the desiccant wheel to perpetuate its cathode reaction. Thus the desiccant wheel and the SOFC system mutually benefit each other resulting in an overall energy efficient air conditioning system.

The present system provides three distinct modes of operation of the air conditioning system namely summer time comfort cooling and dehumidification, winter time comfort heating and humidification and evaporative cooler drying to ward off any mold growth in the evaporative cooler during long periods of non operation. It improves energy efficiency by more efficiently using the waste heat generated by the SOFC system while simultaneously enhancing the durability of the SOFC system by supplying dry air to the SOFC cathode. Furthermore, the system effectively provides the appropriate level of humidity for the conditioned space both during summer time cooling and winter time heating.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the desiccant wheel shown in FIGS. 6 and 7;

FIG. 2 is a cross section view of the desiccant wheel taken at line 4-4 in FIG. 1;

FIG. 3 is a perspective view of the indirect evaporative cooler shown in FIGS. 6 and 7;

FIG. 4 shows the anode and cathode reactions for the SOFC using hydrogen fuel.

FIG. 5 is a schematic of the SOFC system of FIGS. 6 and 7;

FIG. 6 is a schematic of an embodiment of the system in a comfort heating and humidifying mode; and

FIG. 7 is a schematic of an embodiment of the system in a comfort cooling and dehumidifying mode as well as evaporative cooler drying mode.

### DETAILED DESCRIPTION OF THE EXEMPLARY EMBODIMENT

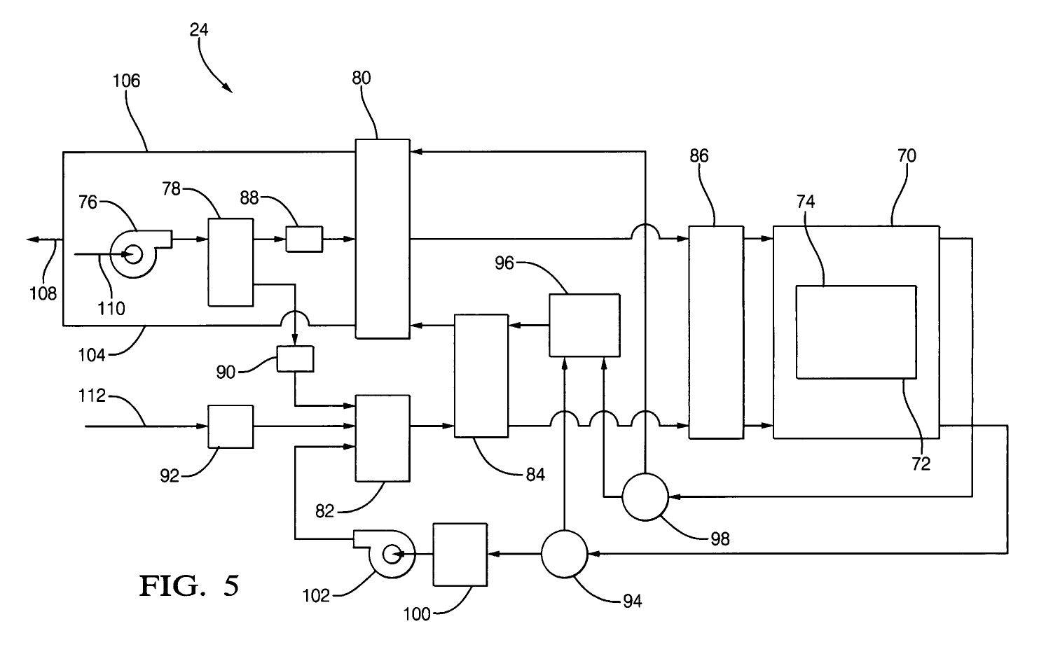

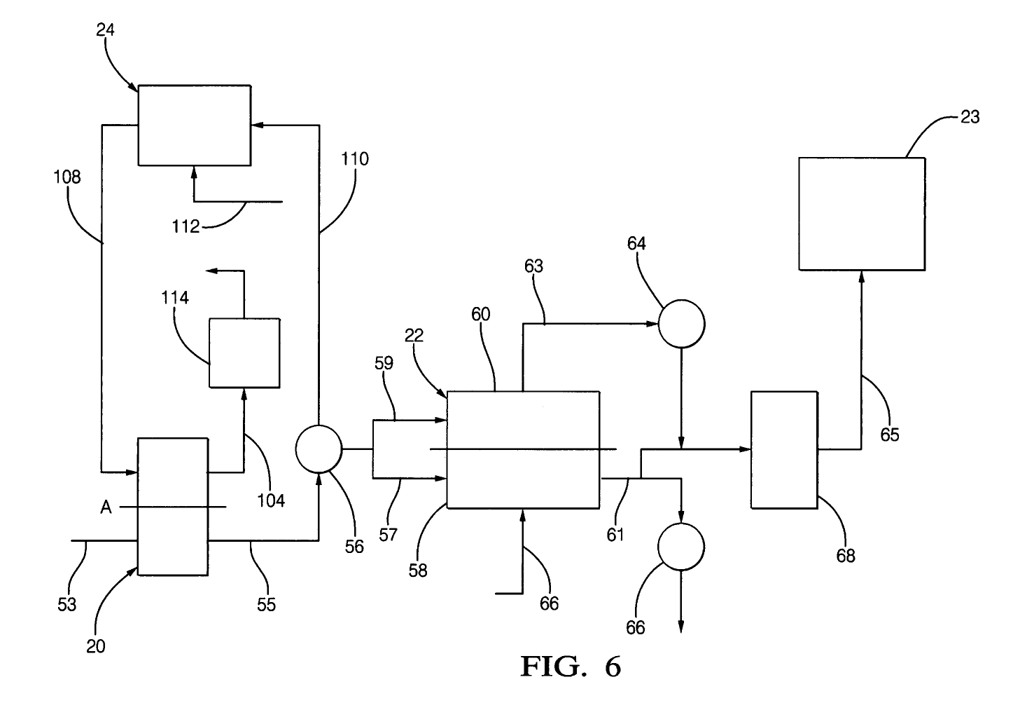

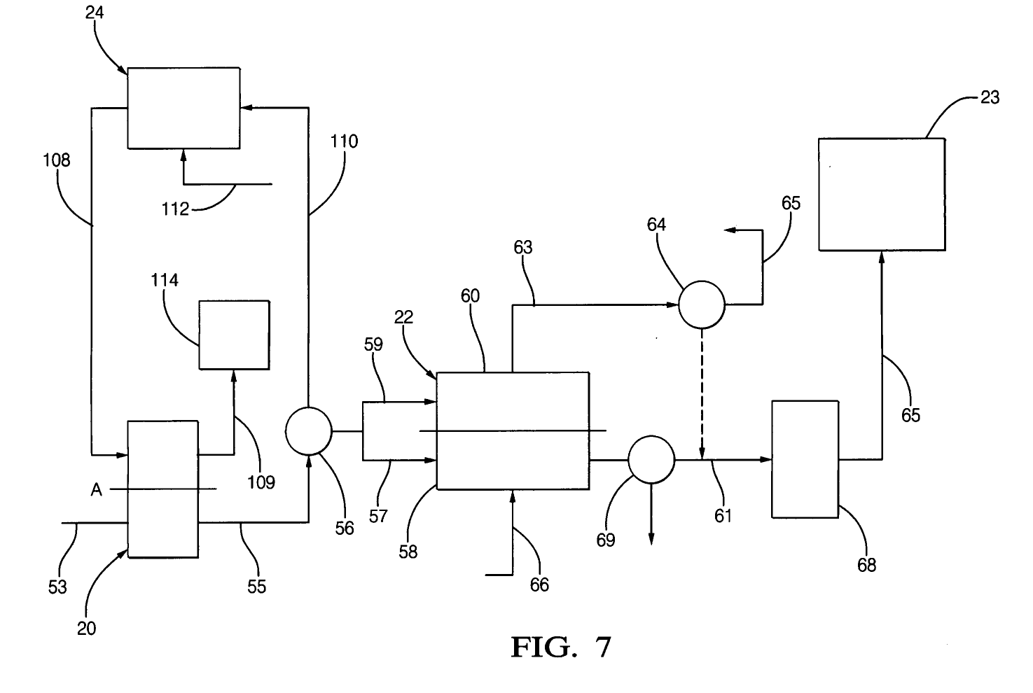

Referring to the Figures, wherein like numerals indicate corresponding parts throughout the several views, an air conditioning system is generally shown in FIGS. 6 and 7. The system includes three main components, namely, a desiccant wheel 20, an evaporative cooler 22 and a SOFC system 24, shown in FIG. 5. The system operates in both a comfort heating and humidifying mode, shown in FIG. 6 and a comfort cooling and dehumidifying mode, shown in FIG. 7. The three main components of the air conditioning system namely a desiccant wheel 20, an indirect evaporative cooler 22 and a SOFC system 24 are described first followed by a description of the comfort heating and cooling system.

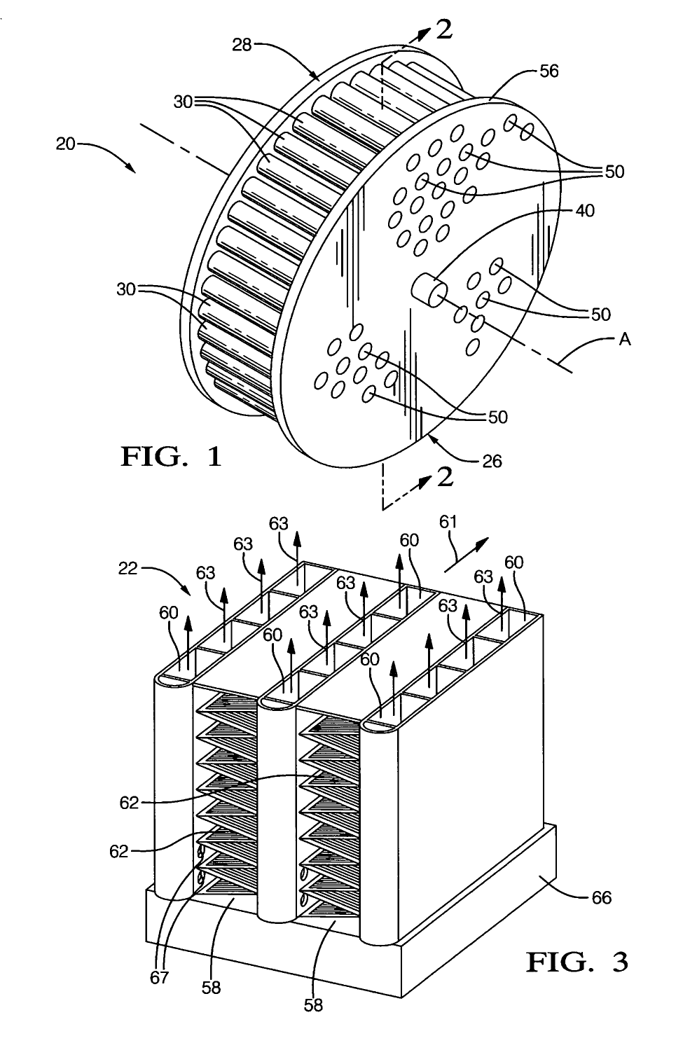

The desiccant wheel 20, which is shown in FIG. 1, includes an inlet plate 26 and an outlet plate 28 each extending radially about an axis A and having a circular periphery defining a wheel diameter. The plates 26, 28 are in parallel relationship with one another. The desiccant wheel 20 includes a plurality of desiccant tubes 30 extending between and through the plates 26, 28 for conveying air through the tubes 30. The desiccant wheel 20 includes a solid desiccant material 32 (not shown) disposed in and lining interior of each of the desiccant tubes 30 for absorbing moisture from ambient air. The desiccant material 32 is any material suitable for water vapor adsorption including silica gel, zeolites, activated alumina, carbons and synthetic polymer.

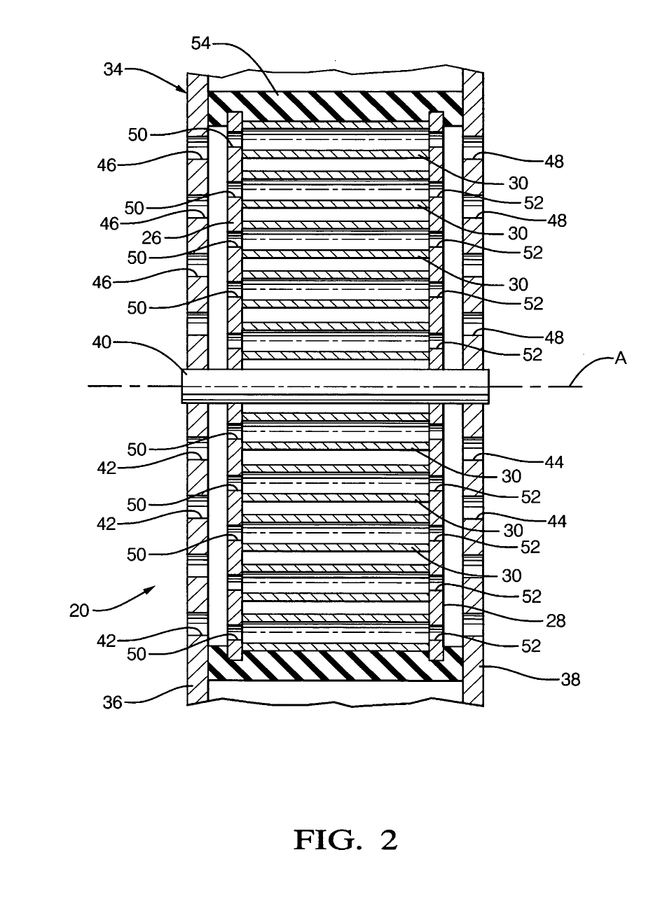

A housing 34, shown in FIG. 2, rotatably supports and encloses the wheel 20. The housing 34 includes an inlet wall 36 in spaced and parallel relationship to the inlet plate 26 of the wheel 20 and an outlet wall 38 in spaced and parallel relationship to the outlet plate 28 of the wheel 20. The wheel 20 includes an axle 40 extending along the axis A through each of the plates 26, 28. The axle 40 is rotatably supported by the housing 34 for rotating the desiccant tubes 30 about the axis A within the housing 34. A small servo motor (not shown) may provide power to slowly rotate the wheel 20 including the tubes 30.

The inlet wall 36 of the housing 34 includes at least one first ambient air inlet 42 on one portion of the inlet wall 36 for directing ambient air stream 53 over the desiccant material 32 in the tubes 30. The passage of the ambient air stream 53 over the desiccant material 32 adsorbs moisture from the ambient air stream 53 onto the desiccant material 32 forming a complex compound. The chemical reaction involved in the adsorption of water vapor H₂O(g) in the solid desiccant material designated M(s) to form the complex compound M.nH₂O(s) is rather straightforward as seen from the following equation representing the reaction of the desiccant material M(s) with n molecules of H₂O(g):

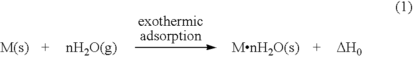

where ΔH₀ is the standard heat of dissociation of the complex M.nH₂O and the symbols (s) and (g) respectively denote solid and gaseous states of the species participating in the chemical reaction.

Equation (1) shows that as the water vapor H₂O(g) is adsorbed by the solid desiccant material, it gives off a quantity of heat ΔH₀, which increases the dry bulb temperature of the dehumidified air stream 55 leaving the desiccant wheel 20. Thus the desiccant material M(s) converts the latent air conditioning load—due to moisture removal—to the sensible air conditioning load, which can be handled by the evaporative cooler 22. While the higher dry bulb temperature of the air stream 55 leaving the desiccant wheel 20 increases the sensible air conditioning load imposed on the evaporative cooler 22, it increases the heat transfer rate in the evaporative cooler 22.

The outlet wall 38 of the housing 34 includes at least one first ambient air outlet 44 on one portion of the outlet wall 38 which is axially aligned with a corresponding ambient first ambient air inlet 42 to define a dehumidification portion of the housing 34. The first ambient air outlets 44 of the housing 34 receive ambient air exiting the tubes 30 of the wheel 20.

The inlet wall 36 of the housing 34 includes at least one second hot air inlet 46 on the remaining portion of the inlet wall 36. The second hot air inlet 46 directs hot exhaust air stream 108, ideally at a temperature of about 300° C., over the desiccant material 32 in the tubes 30 to dissociate the complex compound M.nH₂O thereby removing moisture from the desiccant material 32 into the exhaust air stream 109. The chemical reaction involved in the dissociation of the complex compound M.nH₂O thereby regenerating the desiccant wheel 20 is the reverse of the reaction represented by Eq. (1):

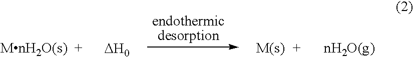

Equation (2) shows that the solid complex compound M.nH₂O(s) can be decomposed by the quantity of heat ΔH₀ supplied to the desiccant material by the hot exhaust 108 from the SOFC system, indicated in FIGS. 5, 6 and 7, to drive off the water vapor H₂O(g) thereby regenerating the desiccant material M(s). The exhaust gas 108 is available at a temperature in excess of 300° C. and at a pressure slightly above the atmospheric pressure. As shown in FIG. 5, the exhaust stream 108 is comprised of two exhaust streams 104 and 106. To adapt the desiccant-assisted system over a wide range of operating conditions, the rotational speed of the desiccant wheel 20 could be varied.

The outlet wall 38 of the housing 34 includes at least one second air outlet 48 on the remaining portion of the outlet wall 38 which is axially aligned with a corresponding second hot air inlet 46 to define a regeneration portion of the housing 34. The second air outlet 48 of the housing 34 receives the exhaust air exiting the tubes 30 of the wheel 20.

Accordingly, in the dehumidification portion of the housing 34, moisture is being removed from ambient air stream 53 flowing through the tubes 30 of the wheel 20, and in the regeneration portion of the housing 34 moisture is being removed from the desiccant material 32 in the tubes 30 into the exhaust air stream 109 flowing through the tubes 30 of the wheel 20. As the wheel 20 rotates, the desiccant material 32 adsorbs moisture in one portion of the housing 34, i.e., the dehumidification portion, and the desiccant material 32 desorbs moisture in the other portion of the housing 34, i.e., the regeneration portion. The volume of the dehumidification section need not be equal to the volume of the regeneration section.

The inlet plate 26 of the wheel 20 defines a plurality of inlet holes 50 for directing ambient air exiting the first ambient air inlets 42 and exhaust air exiting the second hot air inlets 46. Because the wheel 20 rotates, as do the included plates 26, 28, the inlet holes 50 of the inlet plate 26 move between a position in which the inlet holes 50 are aligned with the first ambient air inlets 42 and a position in which the inlet holes 50 are aligned with the second hot air inlets 46. In other words, the inlet holes 50 of the inlet plate 26 alternate between directing hot exhaust air stream 109 and directing ambient air stream 53 as the inlet plate 26 rotates in relation to the housing 34.

The outlet plate 28 of the wheel 20 defines a plurality of outlet holes 52 for directing ambient air exiting the tubes 30 and exhaust air exiting the tubes 30. Similarly, the outlet holes 52 of the outlet plate 28 alternate between directing ambient air stream 53 and directing hot exhaust air stream 109 as the inlet plate 26 rotates in relation to the housing 34.

A rubbing seal 54 extends radially along the wheel 20 and between the inlet and outlet walls 36, 38 for sealing the dehumidification section from the regeneration section, as shown in FIG. 2. The rubbing seal 54 prevents mixing of the incoming moist ambient air stream 53 in the dehumidification portion with hot exhaust air stream 108 in the regeneration portion of the housing 34.

A dehumidified air flow divider 56, shown in FIGS. 6 and 7, is in communication with the first ambient air outlet 44 for dividing the dehumidified air exiting the wheel 20 into a three fractions, namely, a fraction 57 directed to the dry channels of the indirect evaporative cooler 22, a fraction 59 directed to the wet channels of the indirect evaporative cooler 22 and a fraction 110 directed to the SOFC 24.

The evaporative cooler 22, shown in detail in FIG. 3, is in communication with the dehumidified air flow divider 56. The evaporative cooler 22 includes dry channels 58 for receiving the dry fraction 57 of the dehumidified air and for transferring heat from the dry fraction 57 to produce conditioned air 61. The evaporative cooler 22 also includes wet channels 60 extending transversely to the dry channels 58 for receiving the wet fraction 59 of the dehumidified air 55 and for transferring heat from the dry fraction 57 of dehumidified air to the wet channels 60 due to evaporation of liquid water in the wet channels 58.

The evaporative cooler 22 includes a wicking material (not shown) disposed in the wet channels 60 for distributing water from a water supply tank 66 to the wet channels 60. The water disposed in the wicking material evaporates in response to transferring heat from the dry channel 58 thereby producing moisture-laden air in the wet channels 60. Heat is transferred from the dry air fraction of the dehumidified air into the dry channels 58 and thereafter into the wet channels 60 and into the water causing the water to evaporate. Convoluted louvered fins 62 extend between the wet channels 60 and across the dry channels 58 to help facilitate heat transfer from the channels 58, 60. A fraction of the incoming dehumidified air is diverted from the dry channels 58 into the wet channels 60 through air apertures 67 in the separating walls. The air apertures 67 are provided all along the separating walls in the flow direction of air so that progressively cooler air enters the wet channels 60 thereby enhancing the cooling efficiency of the indirect evaporative cooler 22.

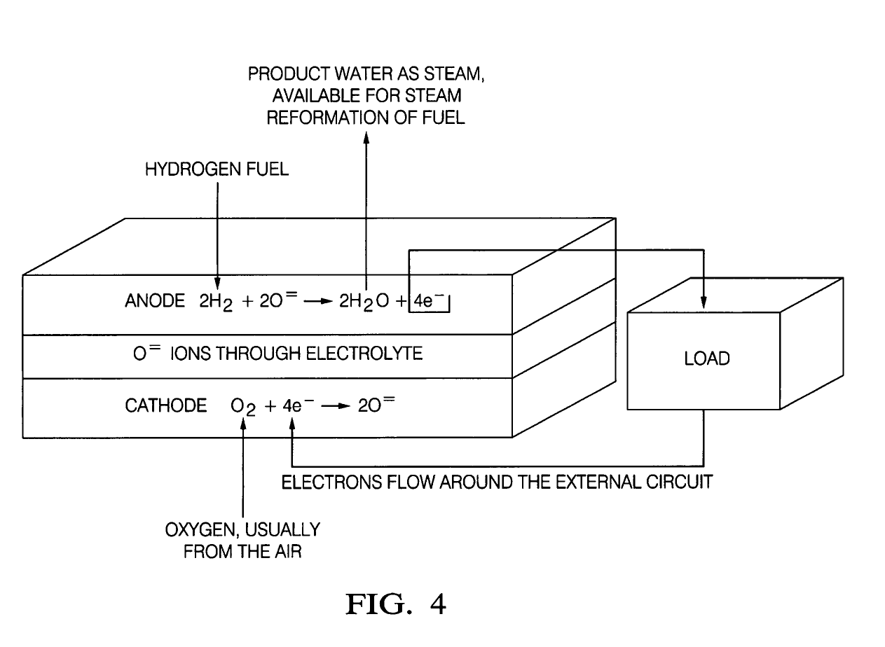

In the present invention, advantage is taken of the high temperature exhaust from the SOFC to regenerate the desiccant wheel 20 and also to provide comfort and other type of heating. Referring to FIG. 5, the SOFC system 24 comprises a fuel cell stack 70 with a plurality of solid oxide fuel cells operating in series. To understand how the SOFC exhaust is generated, it is useful to understand the basic operation of a single SOFC, which uses hydrogen containing reformate as fuel. As indicated in FIG. 4, at the anode of the SOFC the hydrogen (H₂) gas combines with the oxygen ions (O⁼) producing water vapor (H₂O) and releasing electrons (e⁻) as indicated by the following reaction:

2H₂+2O⁼→2H₂O+4e⁻ (3)

This reaction releases energy, which provides the electric power. The cathode of the fuel cell requires oxygen (O₂), which is supplied with properly conditioned air. At the cathode, oxygen (O₂) reacts with electrons (e⁻) flowing round the external circuit to form oxygen ions (O⁼), which flow back through the solid electrolyte to the anode of the fuel cell (vide FIG. 4).

O₂+4e⁻→2I⁼ (4)

As indicated in FIG. 4, the water vapor (steam) generated at the anode is available for steam reformation of the fuel, i.e., for generation of hydrogen from a fuel like LPG used in residential heating. The basic endothermic reforming reaction for a generic hydrocarbon CₙHₘ is as follows.

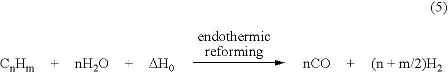

where ΔH₀ is the standard heat of dissociation of the generic hydrocarbon CₙHₘ and H₂O.

The carbon monoxide (CO) generated in the fuel reformation reaction is converted to carbon dioxide (CO₂) and hydrogen (H₂) by steam (H₂O) in accordance with the following reaction called water-gas shift reaction:

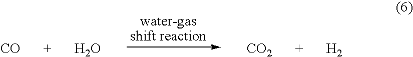

The fuel-reforming and the associated water-gas shift reactions of Eqs. (5) and (4) are carried out normally over a supported base metal (nickel etc.) or precious metal (rhodium etc.) catalyst at elevated temperatures typically 500° C.-1000° C. (depending on the fuel type). The reactions represented by Equations (5) and (6) are reversible and normally reach equilibrium over an active catalyst since at such high temperatures the rates of reaction are very fast. The catalyst of the reaction of Eq. (5) is invariably also suitable for the reaction of Eq. (6). The combination of the two reactions leads to an overall gaseous product, which is a mixture of carbon monoxide (CO), carbon dioxide (CO₂) and hydrogen (H₂) together with unconverted hydrocarbon (CₙHₘ) and steam (H₂O). The actual composition of the product from the reformer is then governed by the temperature of the reactor (actually the outlet temperature), the operating pressure, the composition of the feed gas and the proportion of steam fed to the reactor. In the present invention, the high temperature exhaust from one or more gas streams in the SOFC system provides the heat source for regenerating the desiccant wheel 20 and to provide comfort and other type of heating. Since both the hot dry air exhaust and hot combustor exhaust contain extremely low levels of carbon monoxide and hydrocarbons, these gas streams may be used in the regeneration section of the desiccant wheel 20, even with the possibility of a small amount of leakage into the indirect evaporative cooler 22.

The SOFC system 24, shown in detail in FIG. 5, is in fluid communication with the dehumidified air flow divider 56, or another stream (not shown) of ultra-dry air from the desiccant wheel 20, for receiving the fuel cell fraction of the dehumidified air and for producing electric current. The SOFC system 24 includes a solid oxide fuel cell stack 70 having an anode side 72 for receiving fuel and for discharging unconsumed fuel and combustion products, and having a cathode side 74 for receiving hot air and for discharging oxygen-depleted and still very dry unconsumed hot air. The SOFC stack 70 comprises a plurality of single solid oxide fuel cells in which gaseous reformate fuel is required to be input into the anode side 72 and oxygen, for example from ambient air, is required to be input into the cathode side 74. As shown in FIG. 4, an electrolyte is disposed between the anode side 72 and the cathode side 74 of each fuel cell. The oxygen reacts with electrons on the cathode side 74 to form oxygen ions. The oxygen ions flow back through the electrolyte to the anode side 72 of the fuel cell and thereafter react with the gaseous reformate to form combustion product and release electrons.

The SOFC system 24 (as described below) is typical of a system operating on heavier fuels (such as diesel, kerosene or gasoline). Systems operating on lighter fuels (such as natural gas, alcohols or ammonia) may be less complex in terms of the reforming process. The SOFC system 24 includes a process air blower 76 for delivering the fuel cell fraction of the dehumidified air from the desiccant wheel 20 to the cathode side 74 of the solid oxide fuel cell stack 70. The SOFC system 24 includes a process flow divider 78 in communication with the process air blower 76 for subdividing the fuel cell fraction of the dehumidified air into a cathode side portion and a reformer side portion. Part of the gas generated at the anode side 72 of the fuel cell may be recycled as an input to the reforming process using fuel such as propane, natural gas, kerosene or diesel fuel. More specifically, the reaction between the input fuel, air and recycled anode gas results in a gaseous reformate fuel, rich in hydrogen and carbon monoxide. The reactions in the fuel cell stack 70 and reformer reactor heat exchanger 84 generate a large amount of heat resulting in hot exhaust, providing the heat source for regenerating the desiccant wheel 20.

The SOFC system 24 includes a cathode air heat exchanger 80 in communication with the process flow divider 78 for heating the cathode side 74 portion of the dehumidified air to produce hot air for delivery to the cathode side 74 of the solid oxide fuel cell stack 70.

To regenerate gaseous reformate, the SOFC system 24 includes a feed stream delivery unit 82 in communication. with the anode side 72 of the SOFC stack 70 for receiving input fuel from an input fuel supply to deliver gaseous reformate to the anode side 72 of the SOFC stack 70. The feed stream delivery unit 82 is in communication with the process flow divider 78 for receiving the reformer side portion of the dehumidified air for producing gaseous reformate fuel. The SOFC system 24 includes a reformer reactor heat exchanger 84 in communication with the feed stream delivery unit 82 for heating the gaseous reformate fuel prior to delivery to the anode side 72 of the SOFC stack 70.

The SOFC system 24 includes a equalizing cooler heat exchanger 86 in communication with the cathode air heat exchanger 80 and the reformer reactor heat exchanger 84 for equilibrating the hot air and the gaseous reformate fuel to a reference temperature, or approximately equal desired temperature, prior to delivery to the solid oxide fuel cell stack 70.

The SOFC system 24 includes a first flow controller 88 in communication with the cathode air heat exchanger 80 for measuring the flow rate of the cathode side 74 portion of the dehumidified air. The SOFC system 24 further includes a second flow controller 90 in communication with the feed stream delivery unit 82 for measuring the flow rate of the reformer side portion of the dehumidified air. The SOFC system 24 also includes a fuel metering system 92 in communication with the feed stream delivery unit 82 for controlling the flow rate of the input fuel.

The SOFC system 24 includes an unconsumed fuel flow divider 94 in fluid communication with the anode side 72 of the solid oxide fuel cell stack 70 for dividing the unconsumed fuel exiting the SOFC stack 70 into a first fuel portion and a second fuel portion.

The SOFC system 24 includes a burner 96 in fluid communication with the hot air flow divider 98 and the unconsumed fuel flow divider 94 for combusting a mixture of the first dry air portion and the first fuel portion to create hot exhaust air to be used by the fuel cell system 24 and eventually directed through the regenerating portion of the wheel 20.

The SOFC system 24 includes an anode tail gas cooler 100 in communication with the unconsumed fuel flow divider 94 for cooling the second fuel portion. The SOFC system 24 includes a recycle pump 102 in communication with the anode tail gas cooler 100 for directing the second fuel portion to the feed stream delivery unit 82.

The SOFC system 24 includes a hot exhaust duct 104 in communication with the burner 96 for directing the hot exhaust air through the reformer reactor heat exchanger 84 and the cathode air heat exchanger 80 and for carrying the hot exhaust air from the SOFC system 24 and eventually to the wheel 20.

The SOFC system 24 includes a hot dry air duct 106 in communication with the hot air flow divider 98 for directing the second hot air portion through the cathode air heat exchanger 80 and for carrying the second hot air portion from the fuel cell system 24 and optionally eventually to the desiccant wheel 20 or to other heat recovery devices (not shown).

A desiccant regenerating duct 108 is in communication with the hot dry air duct 106 and the hot exhaust duct 104 using the hot dry air and, optionally, the hot exhaust air to create desiccant regenerating air, or fuel cell exhaust gases, to be directed through the regenerating portion of the desiccant wheel 20.

The second hot air inlets 46 shown in FIG. 2 are in communication with the fuel cell system 24 for directing the desiccant regenerating air through the regenerating portion of the desiccant wheel 20 to cause an endothermic reaction, represented by Eq. (2), with the solid desiccant material 32 to dry the solid desiccant material 32. The desiccant wheel 20 is supported by the axle 40 for rotation about the axis A to alternately move the solid desiccant material 32 between the dehumidifying and regenerating portions to successively expose the solid desiccant material 32 to the desiccant regenerating air stream 108 and to the ambient air stream 53.

An accessory heat exchanger 114 shown in FIG. 6 is in communication with the second air outlet 48 for transferring heat from the desiccant regenerating air and to condense water from the desiccant regenerating air onto the accessory heat exchanger 114.

In operation, the SOFC system 24 produces electric current, represented by Eqs. (3) and (4), and hot exhaust air, represented by Eqs. (5) and (6). The hot exhaust air stream 108 exiting the SOFC system 24 is directed through the regenerating portion of the housing 34 to remove moisture from the desiccant material 32, in accordance with Eq. (2), within the tubes 30 of the desiccant wheel 20 as the tubes 30 rotate into the regenerating portion of the housing 34. Simultaneously, ambient air stream 53 is directed through the dehumidifying portion of the housing 34 wherein moisture from the ambient air is adsorbed, in accordance with Eq. (1), into the desiccant material 32 producing dehumidified air. The dehumidified air stream 55 is directed to the evaporative cooler 22 wherein one fraction 57 of the air is directed to the dry channels 58 to be cooled and another fraction 59 of the air is directed into the wet channels 60 to evaporate water from the wicking material on the surfaces of the wet channels 60 thereby transferring heat from the dry channels 58 of the evaporative cooler 22. When needed, the moisture laden air stream 63 exiting the wet channels 60 can be added back into the conditioned air stream 61 exiting the dry channels 58 to achieve an appropriate level of humidity.

During the summer time, the intent of the comfort cooling and dehumidifying mode, depicted in FIG. 7, is to provide electricity from the SOFC system 24 and to dehumidify and cool the ambient air so as to provide properly conditioned air to the conditioned space 23. In this mode of operation, hot exhaust gas stream 108 from the SOFC system 24 is directed to the regeneration section of the desiccant wheel 20. This hot exhaust is used to remove moisture from the desiccant wheel 20 in accordance with Eq. (2) so as to make it ready to adsorb water vapor from the ambient air in the dehumidification section. The hot exhaust 109 leaving the desiccant wheel is then directed to the heat exchanger 114 to perform auxiliary functions such as water heating. The dehumidified air stream 55 generated by the desiccant wheel 20 is directed to the SOFC system 24 and the indirect evaporative cooler 22 via the proportioning valve 56. The dehumidified air stream 110 directed to the SOFC system 24 is ducted in such a way that it receives the driest air available from the desiccant wheel 20. The balance of the dehumidified air is directed to the indirect evaporative cooler 22, which uses the dehumidified air on the wet side as air stream 59 and on the dry side as air stream 57. The air control valve 56 can provide a method of controlling the amount of cooling capacity of the system by regulating the amounts of the air streams 57 and 59 going through the dry channels 58 and wet channels 60 respectively of the indirect evaporative cooler 22.

The dried and cooled air exiting the indirect evaporative cooler 22 is directed to the conditioned space 23 to provide comfort cooling. Water from the tank 66 is directed to the wet side of the indirect evaporative cooler 22 and used to provide the evaporative cooling. The water exits the indirect evaporative cooler 22 in the form of humid air 63. This humid air is normally directed to the environment as air stream 65. However, there is a valve 64 provided to introduce a portion of this humid air 63 into the cool air path to add humidity to the conditioned space 23 further enhancing the comfort.

During winter time, the intent of the comfort heating and humidifying operation, shown in FIG. 7, is to provide electricity from the SOFC system and to heat and partially humidify air for the conditioned space 23 in an energy efficient manner. In this mode of operation, hot exhaust stream 108 from the SOFC system 24 is directed to the desiccant wheel 20. This hot exhaust is used to provide heat to the desiccant wheel 20, which then rotates at an appropriate speed so as to add heat to the ambient air coming into the system. In this operating mode, the primary function of the desiccant wheel 20 is not to dehumidify the incoming ambient air stream 53, but to preheat the incoming air. The hot exhaust stream 55 leaving the desiccant wheel 20 is then directed to the heat exchanger 114 to perform auxiliary functions such as water heating.

In the winter time comfort heating and humidifying mode, the conditioned air stream 61 exiting the dry channels 58 may be too dry. Therefore, a humid air valve 64 in communication with the wet channels 60 of the evaporative cooler 22 is provided for selectively mixing a portion of the moisture-laden air stream 63 with the conditioned air stream 61 exiting the dry channels 58 resulting in the appropriate level of humidity of air entering the conditioned space 23, as shown in FIG. 7. Additionally, in the heating and humidifying mode, the desiccant wheel 20 rotates at a slower speed and most of the air exiting the desiccant wheel 20 is directed through the dry channels 58 of the evaporative cooler 22.

The ambient air stream 53 entering the air conditioning system first enters the desiccant wheel 20 and heat is transferred from the surfaces of the desiccant wheel 20 to the incoming air. The desiccant wheel rotational speed can be varied to provide more or less heat based on comfort or other factors. This preheated air is then directed to the SOFC system 24 and the indirect evaporative cooler 22 in appropriate amounts.

The indirect evaporative cooler 22 uses the preheated air both in the wet channels 60 and the dry channels 58. The air control valve 56 can provide a method of controlling the amount of heating capacity of the system by regulating the amounts of the air streams 57 and 59 going through the dry channels 58 and wet channels 60 respectively of the indirect evaporative cooler 22.

During winter time operation, there is a desire to minimize the cooling capacity of the indirect evaporative cooler 22 since heating is required for winter time comfort. Also in winter time, there is a need to humidify the hot air entering the conditioned space 23 as the hot air tends to be too dry for comfort. To alleviate this situation, the humid air stream 63 exiting the wet channels 60 of the indirect evaporative cooler 22 is blended with the dry air stream 61 from the dry channels 58 of the indirect evaporative cooler 22 by means of a valve 64 as shown in FIG. 6.

During extreme winter conditions, when additional heat is required in excess of what the SOFC system 24 in conjunction with the desiccant wheel 20 can provide, a more conventional furnace 68 can be utilized to raise the temperature of the air stream to further heat the conditioned space 23.

During evaporative cooler drying operation, the intent of the system is to provide electricity from the SOFC system 24 and to remove all moisture from the indirect evaporative cooler 22. This will enable extended off time of the indirect evaporative cooler 22 without the risk of mold or mildew growth on the surfaces of the indirect evaporative cooler 22.

In the summer time comfort cooling and dehumidifying mode, the humid air valve 64 exhausts the moisture-laden air stream 65 from the wet channels 60 instead of mixing the moisture laden air stream 63 with the conditioned air stream 61 from the dry channels 58 as shown in FIG. 7. The desiccant wheel 20 also rotates at a faster speed during this mode and nearly equal amount of dehumidified air is sent through the dry channels 58 and wet channels 60.

During the evaporative cooler drying mode, a drying valve 69 is in communication with the dry channels 58 of the evaporative cooler 22 for selectively exhausting the conditioned air to the environment to dry the evaporative cooler 22. A home furnace 68 is in communication with the dry channels 58 of the evaporative cooler 22 for transferring heat to the conditioned air for use in a conditioned space 23 in a heating mode.

While the invention has been described with reference to an exemplary embodiment, it will be understood by those skilled in the art that various changes may be made and equivalents may be substituted for elements thereof without departing form the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An air conditioning system comprising:
a desiccant wheel;
a housing rotatably supporting said wheel;
said housing including a first ambient air inlet for directing ambient air through said wheel to condense moisture from the ambient air onto said wheel;
said housing including a first ambient air outlet for receiving dehumidified ambient air exiting said wheel;
said housing including a second hot air inlet for directing hot exhaust air through said wheel to evaporate moisture from said wheel into the exhaust air;
said housing including a second air outlet for receiving humidified hot exhaust air exiting said wheel;
an evaporative cooler in communication with said first ambient air outlet;
a fuel cell system in communication with said second hot air inlet of said housing;
whereby said desiccant wheel transfers moisture from the ambient air to said wheel and the evaporative cooler transfers heat from the dehumidified air to supply conditioned air and said fuel cell to produce electric current and hot exhaust air and the hot exhaust air removes the moisture from said wheel thereby regenerating said wheel,

2. The system as set forth in claim 1 including a dehumidified air flow divider in communication with said first ambient air outlet for dividing the dehumidified air exiting said wheel into a dry fraction and a wet fraction and a fuel cell fraction;
wherein said evaporative cooler is in communication with said dehumidified air flow divider and includes dry channels for receiving the dry fraction of the dehumidified air and for transferring heat from the dry fraction to produce conditioned air stream and wet channels for receiving and adding moisture to the wet fraction of the dehumidified air stream and for transferring heat from the dry channels; and
wherein said fuel cell is in fluid communication with said dehumidified air flow divider for receiving the fuel cell fraction of the dehumidified air and for producing electric current and hot exhaust air.

3. The system as set forth in claim 1 wherein said wheel includes a pair of plates extending radially about an axis and being in parallel relationship with one another and a plurality of desiccant tubes extending between said plates for conveying air through said tubes and a desiccant material disposed in each of said desiccant tubes,

4. The system as set forth in claim 3 wherein said wheel including an axle extending along said axis and rotatably supported by said housing,

5. The system as set forth in claim 4 wherein said desiccant wheel includes an inlet plate and an outlet plate each having a circular periphery defining a wheel diameter and said desiccant tubes extend through said plates,

6. The system as set forth in claim 5 wherein said housing includes an inlet wall in spaced and parallel relationship to said inlet plate of said wheel and an outlet wall in spaced and parallel relationship to said outlet plate of said wheel,

7. The system as set forth in claim 6 wherein said air inlets of said inlet wall are on one portion of said inlet wall and said air outlets of said outlet wall are on one portion of said outlet wall and are axially aligned with a corresponding ambient air inlet to define a dehumidification portion of said housing;
said second hot air inlets of said inlet wall are on the remaining portion of said inlet wall and said second air outlets are on the remaining portion of said outlet wall and are axially aligned with a corresponding second hot air inlet to define a regeneration portion of said housing,

8. The system as set forth in claim 7 wherein said inlet plate of said wheel defines a plurality of inlet holes for directing ambient air exiting said first ambient air inlets and exhaust air exiting said second hot air inlets and said outlet plate of said wheel defines a plurality of outlet holes for directing ambient air exiting said tubes and exhaust air exiting said tubes,

9. The system as set forth in claim 8 wherein said wheel further comprises a seal extending along said wheel diameter and between said inlet and outlet walls for sealing said dehumidification section from said regeneration section.

10. The system as set forth in claim 3 further comprising said second hot air inlets being in communication with said fuel cell system for directing the desiccant regenerating air stream through said desiccant wheel to cause an endothermic reaction with said solid desiccant material to dry said solid desiccant material,

11. The system as set forth in claim 1 wherein said fuel cell system includes a solid oxide fuel cell stack having an anode side for receiving reformate fuel and for discharging unconsumed fuel and combustion product and having a cathode side for receiving hot air and for discharging unconsumed oxygen-depleted hot air.

12. The system as set forth in claim 11 further comprising said fuel cell system including a process air blower for delivering the fuel cell fraction of the dehumidified air stream from said desiccant wheel to said cathode side of said solid oxide fuel cell stack,

13. The system as set forth in claim 12 wherein said fuel cell system includes a process flow divider in communication with said process air blower for subdividing the fuel cell fraction of the dehumidified air into a cathode side portion and a reformer side portion.

14. The system as set forth in claim 13 wherein said fuel cell system includes a cathode air heat exchanger in communication with said process flow divider for heating the cathode side portion of the dehumidified air to produce hot air for delivery to said cathode side of said solid oxide fuel cell stack,

15. The system as set forth in claim 14 wherein said fuel cell system includes a feedstream delivery unit in communication with said anode side of said solid oxide fuel cell stack for receiving input fuel from an input fuel supply to deliver gaseous reformate to said anode side of said solid oxide fuel cell stack,

16. The system as set forth in claim 15 wherein said fuel cell system includes a reformer reactor heat exchanger in communication with said feedstream delivery unit for heating the gaseous reformate fuel prior to delivery to said anode side of said solid oxide fuel cell stack,

17. The system as set forth in claim 16 wherein said fuel cell system includes a equalizing cooler heat exchanger in communication with said cathode air heat exchanger and said reformer reactor heat exchanger for equilibrating the hot air and the gaseous reformate fuel to a reference temperature prior to delivery to said solid oxide fuel cell stack,

18. The system as set forth in claim 15 wherein said feed stream delivery unit is in communication with said process flow divider for receiving the reformer side portion of the dehumidified air for producing gaseous reformate fuel.

19. The system as set forth in claim 14 wherein said fuel cell system includes a first flow controller in communication with said cathode air heat exchanger for measuring the flow rate of the cathode side portion of the dehumidified air and a second flow controller in communication with said feed stream delivery unit for measuring the flow rate of the reformer side portion of the dehumidified air and a fuel metering system in communication with said feed stream delivery unit for controlling the flow rate of the input fuel.

20. The system as set forth in claim 16 wherein said fuel cell system includes an unconsumed fuel flow divider in fluid communication with said anode side of said solid oxide fuel cell stack for dividing the unconsumed fuel exiting the solid oxide fuel cell stack into a first fuel portion and a second fuel portion;
wherein said fuel cell system includes a burner in fluid communication with said hot air flow divider and said unconsumed fuel flow divider for combusting a mixture of the first dry air portion and the first fuel portion to create hot exhaust air.

21. The system as set forth in claim 20 wherein said fuel cell system includes an anode tail gas cooler in communication with said unconsumed fuel flow divider for cooling the second fuel portion and a recycle pump in communication with said anode tail gas cooler for directing the second fuel portion to said feedstream delivery unit,

22. The system as set forth in claim 21 wherein said fuel cell system includes a hot exhaust duct in communication with said burner for directing the hot exhaust air through said reformer reactor heat exchanger and said cathode air heat exchanger and for carrying the hot exhaust air from the fuel cell system and a hot dry air duct in communication with said hot air flow divider for directing the second hot air portion through said cathode air heat exchanger and for carrying the second hot air portion from the fuel cell system,

23. The system as set forth in claim 22 further comprising a desiccant regenerating duct in communication with at least one of said hot dry air duct and said hot exhaust duct for using the hot dry air and the hot exhaust air to create desiccant regenerating air and an accessory heat exchanger in communication with said second air outlet for transferring heat from the desiccant regenerating air to condense water from the desiccant regenerating air onto the accessory heat exchanger,

24. The system as set forth in claim 23 wherein said evaporative cooler includes a wicking material disposed in said wet channels for distributing water from a water supply to said wet channels for evaporating in response to receiving heat from the dry fraction to produce moisture laden air in said wet channels; and further comprising a humid air valve in communication with said wet channels of said evaporative cooler for selectively mixing a portion of the moisture laden air stream with the conditioned air stream exiting said dry channels and a drying valve in communication with said dry channels of said evaporative cooler for selectively exhausting the conditioned air to the environment to dry said evaporative cooler,
